(19) United States
(12) Patent Application Publication
(10) Pub. No.: US 2010/0012216 A1
(43) Pub. Date: Jan. 21, 2010

(54) Method and Apparatus for Making Irregularly Textured Hose

(76) Inventors: Valerie Salatino, San Diego, CA (US); Nancy Moran, Escondido, CA (US)

Correspondence Address: QUARLES & BRADY LLP, ONE SOUTH CHURCH AVENUE, SUITE 1700, TUCSON, AZ, 85701-1621, US

(21) Appl. No.: 12/569,647

(22) Filed: Sep. 29, 2009

Related U.S. Application Data
(63) Continuation-in-part of application No. 11/214,713, filed on Aug. 31, 2005.

(51) Int. Cl. F16L 11/00; B29C 59/02

(52) U.S. Cl. 138/118; 264/293; 425/385

(57) ABSTRACT

Stamping, embossing, imprinting and casting methods and apparatus for manufacturing a garden hose having an outer surface including a plurality of irregularly textured areas extending radially from that surface so that frictional engagement with the surface is increased and the surface is physically camouflaged to be vine-like in appearance.

### CROSS REFERENCE TO RELATED APPLICATION

This application is a continuation-in-part of U.S. patent application Ser. No. 11/214,173, filed on Aug. 29, 2005.

### BACKGROUND OF THE INVENTION

1. Field of the Invention

The invention relates generally to an apparatus and method for making a hose that is especially useful in that it can be securely gripped when wet and is physically camouflaged to be vine-like in appearance to blend in with sensitive environments, such as zoo habitats.

2. Description of the Related Art

Many hoses of various types (e.g., garden hoses, fire hoses, utility hoses, etc.) exist have been designed to be structurally improved (e.g., “kink-free”), camouflaged, or aesthetically more pleasing in terms of color or ornamental surface design.

Thus, U.S. Pat. No. D498,825 by Fu discloses a hose having two separate chambers through which water runs. By providing a hose having two chambers with diameters smaller than the same hose would have with a single chamber, the velocity of fluid flow is increased. Also, U.S. Pat. No. 6,789,579 by Ryhman provides a hose with rectangular or other regular geometrical grooves that are uniformly distributed over the hose to provide areas of expansion when the hose is under pressure.

In terms of designs with aesthetic considerations, U.S. Pat. No. D478,969 by Mezzalira, U.S. Pat No. Des.381,405 by Waidele et al., and U.S. Pat. No. Des. 413,657 by Lidgett all disclose hoses that feature surface ornamentation consisting of a variety of patterns. All of the surface ornamentations featured in these patents are either regular geometric patterns or non-dimensional (i.e., non-textured) surface adornment. While each of these hoses may be suitable for their intended use, the overall smoothness of the surface of the hose can make them quite slippery when wet. Moreover, all of these hoses tend to stand out from the surrounding environment, making them unsuitable for use in places such as animal habitats. This can be problematic because any foreign object that does not blend-in with the surrounding environment may attract an animal's attention and result in the hose being damaged or in harm being inflicted upon the animal through, for example, accidental ingestion.

U.S. Pat. No. D469,520 by McLean discloses a hose that appears to be designed to resemble a snake. While this design may illicit an avoidance behavior due to its serpent-like appearance, it does not provide any surface features that improve a holder's grip when the hose is wet. It further may lead to distress if an animal believes it to be a snake.

Various hot embossing and stamping machines exist to impart a image or design on a flat or panel-like substrate. For example, U.S. Pat. No. 5,921,175 discloses an embossing station with a work support, an anvil roll, and embossing wheels above the anvil roll. While such devices may be suitable for their intended purpose, there is still a need for an apparatus and method for imparting an irregular texture to a tubular item such as a hose.

Thus, there remains a need in the art for an apparatus and method that produces a hose that mimics a natural environmental feature to provide effective camouflage while also providing surface structure that can improve frictional engagement (e.g., a holder's grip) under wet conditions.

### SUMMARY OF THE INVENTION

The invention relates in general to methods and apparatus for manufacturing a hose that includes an outer surface with a plurality of irregularly textured areas extending radially therefrom.

In one embodiment of the invention, the hose includes a hollow tubular member having an inner surface and an outer surface, with the inner surface being in contact with a conveyed fluid and a plurality of irregularly textured areas extending radially from the outer surface. In certain embodiments, the irregularly textured areas comprise indentations. In other embodiments, the irregularly textured areas include a combination of indentations and protuberances. In still other embodiments, the plurality of irregular textured areas comprise a vine-like appearance. Preferably, the embodiments featuring a vine-like appearance include indentations and protuberances that vary in depth or height from 1/128 inches to 0.5 inches.

In certain embodiments, the hose includes a tubular structure with a first material and a second material, wherein a plurality of irregularly textured areas are disposed upon an outer surface of the second material. The first material preferably is a reinforcing material, such as nylon mesh. Also preferably, the first material and second material are integrally formed (rather than disposed atop each other).

In other embodiments of the invention, a method for manufacturing a fluid conveyance apparatus is provided, comprising the step of casting a flexible material into a hollow, tubular structure within a mold, wherein a plurality of irregularly textured areas are formed within an outer surface of, and extend radially from, the tubular structure.

The method of the invention may further include the step of disposing another material within the mold prior to casting the flexible material such that the other material is integrally formed within the flexible material. Preferably, the other material provides a reinforcing material that augments the structural integrity of the tubular structure.

In certain embodiments of the invention, the method includes a unique mold. The mold includes a first mold member defining a tubular structure and having a length and an inner surface in contact with a casting material, wherein the inner surface contains a plurality of irregularly textured areas defining a combination of indentations and protuberances, and a second mold member comprising a cylindrical member disposed substantially centrally along the length of the first mold member.

Preferably, a garden hose having an outer surface with a plurality of irregularly textured areas formed within and extending radially therefrom is produced according to a process involving stamping, imprinting, or casting. The plurality of irregular textured areas form a vine-like appearance of indentations and protuberances that vary in depth or height from 1/128 inch to 0.5 inch above and below an average outer circumference of the hose, which may be accomplished, by, for example, an apparatus having two pairs of imprinting wheels fixed upon a support member. One of the pairs of imprinting wheels is disposed perpendicular to the other along a co-linear pathway such that the garden hose is imprinted on the entire outer surface by being fed through the pairs of imprinting wheels along this pathway. Preferably, the imprint wheels contain protuberances and indentations over about 20-30% of the inner concave surface of each stamping plate. The 20-30% coverage is believed to provide a desirable texture and camouflaged appearance to the hose while advantageously allowing each wheel to imprint more cleanly (i.e., with less or no “sticking” to the hose).

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 schematically depicts a first embodiment of the invention in perspective view.

FIG. 2 schematically illustrates a cross-sectional view taken along line 2-2 in FIG. 1.

FIG. 3 schematically depicts an embodiment of disassembled mold of the invention in elevational view.

FIG. 4 schematically illustrates the assembled embodiment featuring the components of the mold of the invention shown in FIG. 3.

FIG. 5 schematically illustrates another embodiment of the invention in cross-section.

FIG. 6 is a perspective view of an imprinting/embossing apparatus of the invention.

FIG. 7 is an enlarged back view of one pair of imprinting wheels from the apparatus of FIG. 6.

FIG. 8 is an enlarged plan view of one imprinting wheel of the embodiment shown in FIG. 6.

### DETAILED DESCRIPTION OF THE PREFERRED EMBODIMENTS

The invention generally relates to a hollow tubular hose having an inner surface and an outer surface featuring a plurality of irregularly textured areas extending radially therefrom.

As used herein, the term “texture” or “textured” is defined as a dimensional quality, as opposed to a flat or smooth aspect, imparted to the exterior of a hose.

As used herein, the phrase “average outer circumference” is defined as the cross-sectional circumference corresponding to a sectional radius equal to the average radial distance of all protuberance tops and indentation bottoms of the irregularly textured outer surface of the tubular structure.

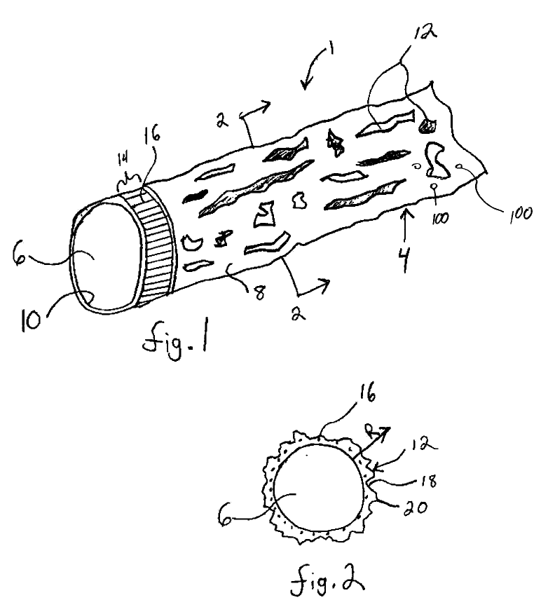

Turning to the figures, wherein like numerals indicate like elements, FIG. 1 illustrates in perspective view a first embodiment of the invention. The hose 1 includes a tubular structure 4 defining a hollow area 6 running the length of tubular structure 4. Tubular structure 4 has an outer surface 8 and inner surface 10 that contacts a fluid 5 being conveyed therethrough. Preferably, inner surface 10 is smooth, while outer surface 8 includes a plurality of irregularly textured areas 12 that are integrally formed with surface 8. Also, as exposed in cut-away section 14, the tubular structure 4 preferably contains a second material (in this case nylon chords 16) that is integrally formed between the outer surface 8 and inner surface 10.

One aspect of the plurality of irregularly textured areas is to provide for increased frictional engagement. For example, a user holding the hose 1 under wet conditions would benefit from the irregular texture of the outer surface in that grip would improve. Moreover, augmented frictional engagement between the apparatus 1 and a secondary structure (e.g. a tree branch) is useful for better securing the apparatus in a particular position or location.

Turning to a cross-sectional view of apparatus 1 along line 2-2, as shown in FIG. 2, the plurality of irregularly textured areas 12 are disposed upon the entire circumference and extend radially (arrow R) from outer surface 8 of tubular structure 4. Again, the tubular structure 4 contains a second material (nylon chords 16), which preferably act as a reinforcing material.

The apparatus 1 of FIGS. 1 and 2 is preferably configured to mimic a natural environmental feature. Thus, the plurality of irregular textured areas 12 may, for example, be configured to provide a vine-like appearance consisting of irregular indentations 18 and irregular protuberances 20.

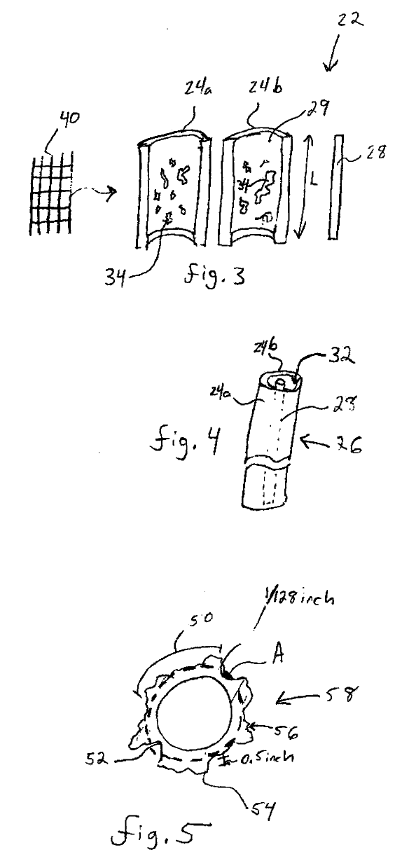

FIGS. 3 and 4 illustrate a mold 22 according to the invention. The mold 22 includes a first mold member 24a and 24b that, when assembled together, define the tubular structure 26 of FIG. 4, and a second mold member 28. The first mold member 24a and 24b have a defined length L and an inner surface 29 in contact with a casting material 32. The inner surface 29 of first mold member 24a and 24b contains a plurality of irregularly textured areas 34 that may be convex, concave or a combination of both, depending on a desired number of indentations and protuberances to appear in the outer surface of the final apparatus.

The second mold member 28 in this embodiment is substantially cylindrical and disposed centrally within, and along the length of, the first mold member 24a and 24b. Reinforcing mesh 40 may be disposed along the inner surface 29 of first mold member 24a and 24b such that mesh 40 will be enveloped by (i.e., made integral with) casting material 32 during the molding process. Upon cooling of the casting material 32, second mold member 28 is removed to reveal a cavity within the casting material.

In one preferred embodiment of the mold 22, the inner surface 29 forms a vine-like appearance that is achieved through indentations and protuberances that vary in depth or height, respectively. Preferably, a plurality of irregular textured areas are produced that form a vine-like appearance of indentations and protuberances that vary in depth or height from 1/128 inch to 0.5 inch above and below an average outer circumference of the hose. The indentations and protuberances may then be further modified (e.g., colored or coated) to suite a particular application.

The mold 24a and 24b further may be used as a pair of stamping plates. Thus, the inner surface 29 (which is shown to be concave) preferably would contain indentations and protuberances that vary in depth or height from 1/128 inch to 0.5 inch disposed over about 20-30% of the inner concave surface of each stamping plate.

Another aspect of the invention relates to a method for manufacturing a hose having the following steps: (a) providing a flexible material into a mold defining a hollow tubular structure; and (b) forming a plurality of irregularly textured areas within an outer surface of the tubular structure such that the plurality of irregularly textured areas extend radially from the outer surface. While a manual casting process utilizing the mold of FIGS. 3 and 4 is contemplated for use according to the method of the invention, injection molding and other techniques known in the art may also be utilized. Moreover, a further step of disposing a material within the mold prior to providing flexible casting material (such as rubber) is preferably practiced to provide the tubular structure with reinforcement.

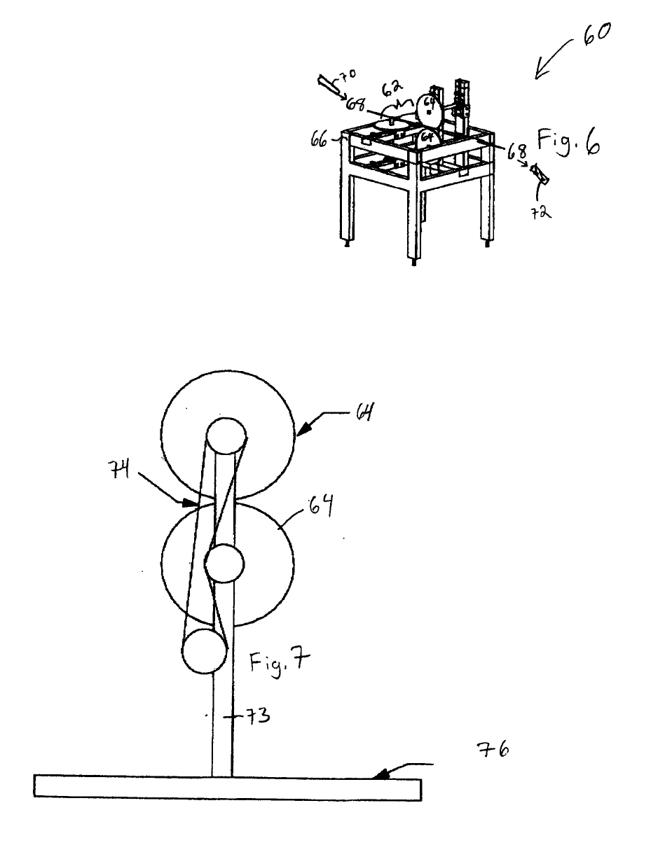

Following the method of the invention, the hose 1 shown in FIG. 1 may be formed. Alternatively, different embodiments, such as that pictured in cross-section in FIG. 5, are created. In the embodiment of FIG. 5, irregularly textured areas are formed to include a combination of indentations 52 and protuberances 54 into the outer surface 56 of tubular structure 58.

Also as shown in FIG. 5, the plurality of irregularly textured areas may be formed to resemble the appearance of a vine or bark consisting of indentations 52 and protuberances 54 that vary from 1/128 inch to 0.5 inch below or above an average outer diameter (the dashed line designated A) of the tubular structure.

Thus, a garden hose having an outer surface that includes a plurality of irregularly textured areas formed within and extending radially therefrom is produced by one of several processes. Preferably, the plurality of irregular textured areas comprise a vine-like appearance of indentations and protuberances that vary in depth or height from 1/128 inch to 0.5 inch above and below an average outer circumference of the garden hose and are produced by a process involving stamping, imprinting (including embossing), or casting of the plurality of irregular textured areas.

Turning to FIG. 6, the process for making a hose of the invention that involves imprinting may further comprise utilizing an apparatus 60 having two pairs of imprinting wheels 62 and 64 fixed upon a support member 66, with one of the pairs of imprinting wheels disposed perpendicular to the other along a co-linear pathway 68 such that a garden hose 70 is imprinted on substantially the entire outer surface 72 by being fed through the pairs of imprinting wheels along pathway 68. The wheels may be heated (or the hose material) by conventional means to best effect imprinting.

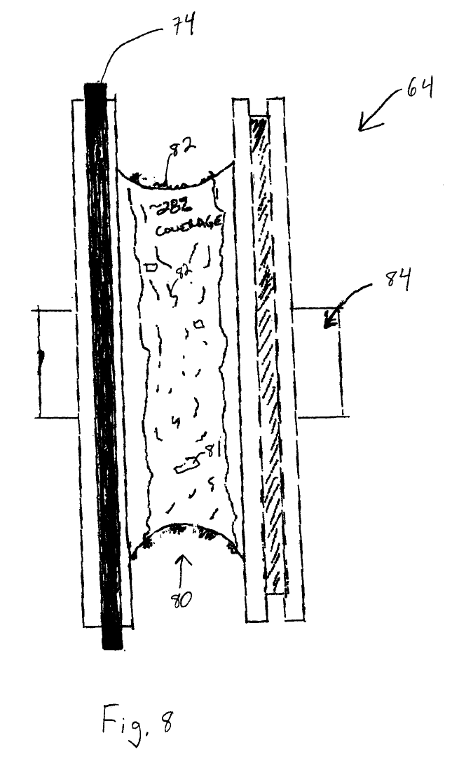

As seen in magnified view from the back and side in FIG. 7, a pair of wheels 64 are rotatably mounted on a support arm 73 and driven by timing belt 74. The support arm 73 is fixed to a base member 76 as shown.

FIG. 8 depicts an enlarged view of one of the two pairs of wheels (which are all similarly designed). The wheel 64 has a concave surface area 80 containing indentations 81 and protuberances 82 that vary in depth or height from 1/128 inch to 0.5 inch disposed over about 20-30% of the concave surface 80 that comes in contact with and imprints/embosses the hose being passed through the apparatus as shown schematically in FIG. 6. A hub 84 provides an opening for an axle (not shown) for mounting wheel 64 to support arm 73.

Thus, an apparatus for manufacturing a hose having a plurality of irregular textured areas is described that includes the steps of providing a flexible and hollow tubular material to an imprinting or stamping area and forming a plurality of irregularly textured areas within substantially an entire outer surface of the tubular material, whereby the flexible and hollow tubular material is imprinted or stamped to produce an irregularly textured vine-like appearance of indentations and protuberances that vary in depth or height from 1/128 inch to 0.5 inch above and below an average outer circumference of the outer surface.

Depending on the tubular material, the step of forming the irregularly textured areas includes pre-heating the tubular material prior to the forming step. Moreover, the forming step may utilize a release agent on the material when it is imprinted or stamped.

### Example of Process

Utilizing the apparatus shown in FIG. 6, the pairs of imprinting wheels are heated to about 260 F and a rubber hose is fed through the co-linear pathway 68. Of course the temperature of the wheels and or hose material will depend on the hose material used such that good impressions are made. A release agent may be applied to the imprinting wheels as needed to prevent or minimize possible build-up of hose material wrought from the imprinting process.

Also, the hose material chosen may be a combination of two or more durometers. For example, a dark brown material with a higher melting point may be combined with a lighter brown material with a lower melting point such that the application of the imprinting wheels will achieve a color integration and “marbling” effect that will enhance the vine-like texture of the hose.

Seeping holes 100 (see FIG. 1) maybe added before, during, or after the imprinting such that the hose may be used for “soaking” and similar irrigation activities.

In view of the disclosure above, it is readily seen that the invention is especially useful for applications in which a camouflaged hose with improved frictional engagement properties would be desirable.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. A garden hose having an outer surface, said outer surface having a plurality of irregularly textured areas formed within and extending radially therefrom, wherein said plurality of irregular textured areas comprise a vine-like appearance of indentations and protuberances that vary in depth or height from 1/128 inch to 0.5 inch above and below an average outer circumference of said hose, wherein the garden hose is produced by a process involving stamping, imprinting, or casting of the plurality of irregular textured areas comprising a vine-like appearance of indentations and protuberances that vary in depth or height from 1/128 inch to 0.5 inch above and below said average outer circumference.

2. The garden hose of claim 1, wherein said process involving imprinting further comprises utilizing an apparatus having two pairs of imprinting wheels fixed upon a support member, with one of the pairs of imprinting wheels disposed perpendicular to the other along a co-linear pathway such that said garden hose is imprinted on substantially the entire outer surface by being fed through said pairs of imprinting wheels along said pathway.

3. The garden hose of claim 2, wherein said two pairs of imprinting wheels of said apparatus each have a concave surface area containing indentations and protuberances that vary in depth or height from 1/128 inch to 0.5 inch disposed over about 20-30% of said concave surface area of each imprinting wheel.

4. The garden hose of claim 1, wherein said process involving stamping comprises a pair of stamping plates each having an inner concave surface that includes a textured area corresponding to a vine-like appearance of indentations and protuberances that vary in depth or height from 1/128 inch to 0.5 inch.

5. The garden hose of claim 4, wherein said pair of stamping plates contain indentations and protuberances that vary in depth or height from 1/128 inch to 0.5 inch disposed over about 20-30% of said inner concave surface of each stamping plate.

6. The garden hose of claim 1, wherein a plurality of seeping holes are formed through the hose.

7. A method for manufacturing a hose having a plurality of irregular textured areas, comprising the steps of:
providing a flexible and hollow tubular material to an imprinting or stamping area;
and forming a plurality of irregularly textured areas within an entire outer surface of said tubular material, wherein said flexible and hollow tubular material is imprinted or stamped to produce an irregularly textured vine-like appearance of indentations and protuberances that vary in depth or height from 1/128 inch to 0.5 inch above and below an average outer circumference of said outer surface.

8. The method of claim 7, wherein said step of forming said irregularly textured areas includes pre-heating said tubular material prior to said forming step.

9. The method of claim 7, wherein forming said irregularly textured areas includes utilizing a release agent on said material when it is imprintcd or stamped.

10. The mold of claim 9, wherein said indentations and protuberances that vary in depth or height from 1/128 inch to 0.5 inch are disposed over only about 20-30% of said inner surface area of said first mold member.
